(19) United States
(12) Patent Application Publication
(10) Pub. No.: US 2008/0290175 A1
(43) Pub. Date: Nov. 27, 2008

(54) Layer-built body having hidden barcode and figures thereof

(75) Inventors: Alfred Lean-Foo Chen, Tainan County (TW); Shuo-Fang Liu, Tainan County (TW); Yuei-An Liou, Tainan County (TW); Hsin-His Lai, Tainan County (TW); Meng-Hsuan Lee, Tainan County (TW); Ying-Hsiu Chen, Tainan County (TW); Chen-Yuan Kao, Tainan County (TW); Chang-Ching Chien, Tainan County (TW); Jung-Hao Chi, Tainan County (TW); Cheng-Yu Lu, Tainan County (TW)

Correspondence Address: BIRCH STEWART KOLASCH & BIRCH, PO BOX 747, FALLS CHURCH, VA, 22040-0747, US

(73) Assignees: Alfred Lean-Foo CHEN, Yongkang City (TW); Shuo-Fang LIU, Yongkang City (TW); Chen-Yuan KAO, Yongkang City (TW)

(21) Appl. No.: 12/076,816

(22) Filed: Mar. 24, 2008

(30) Foreign Application Priority Data
May 24, 2007 (TW) 096118456

(51) Int. Cl. G06K 19/00

(52) U.S. Cl. 235/487

(57) ABSTRACT

A layer-built body having hidden barcodes and figures thereof is disclosed in the invention, so as to allow barcode scanning devices to read the barcodes, the layer-built body comprising: a lenticular lens sheet divided into a first surface and a second surface, and the first surface has a plurality of convex lens-shaped optical structures disposed thereon; a patterned layer printed with trademarks or figures, and divided into a plurality of striped images; and at least a barcode layer printed with information about barcodes and divided into a plurality of striped images. The striped images of the barcode layer are alternated with the striped images of the patterned layer to make a synthesized image layer, and are combined with the second surface of the lenticular lens sheet; wherein when a viewer looks at the layer-built body from an ordinary angle, the optical structures of the lenticular lens sheet allows the viewer to see contents of the patterned layer completely, and when the layer-built body is tilted at specific angles, the optical structures of the lenticular lens sheet allows barcode scanning devices to read contents of the barcode layer. Therefore, information about barcodes and figures may be provided on a fixed surface area simultaneously.

### FIELD OF THE INVENTION

The invention relates to a layer-built body having hidden barcodes and figures thereof, and more particularly to a labeling that provides figures for viewing and a plurality of barcodes for reading on a fixed surface area.

### DESCRIPTION OF PRIOR ART

The barcodes printed on packages or outer surfaces of products were firstly promoted by the Supermarket Institute (SMI) with the aim of managing the flow of goods in department stores or supermarkets, so that an enormous amount of labor, time, and resources may be saved from spending on inputting information about the goods into management systems. The barcode system was officially initiated in 1973 under the name of Universal Product Code (UPC), and then the concept and technology of the barcode system was accepted in Europe, which was followed by the publication and promotion of the European Article Number (EAN) by 12 European industrialized countries; the EAN Association was established in 1977, which further spread the concept of the barcode system to other regions. As a result, the barcode system became accepted internationally, and products manufactured nowadays are printed with not only trademarks, but also barcodes as well.

Although the aforesaid barcode system has advantages like the saving of a lot of labor and resources, the barcodes are after all designed to allow scanners to read, and are not created with any sense of aesthetics to humans. But in an age in which the design of products may increase competitiveness of such products, competitors in various industries are always trying to create their own unique brands and styles in order to gain a competitive edge over others. Therefore, it is essential to have stylish and unique trademarks printed on the most eye-catching spots on products or packages. In contrast, barcodes that may disrupt the visual aesthetics of products should be printed on the least obvious locations on products or packages. However, such arrangement in the location of barcodes and trademarks creates unexpected problems for the people who manage the flow of goods, because trademarks that are printed on the most obvious locations may not be used by the management system to identify goods; on the other hand, though barcodes may help the management system identify goods, they are always printed at corners or the least obvious locations. Consequently, people who need to manage the flow of goods must spend a lot of time on looking for barcodes before they can input the barcodes into the management system for identification of goods, which forces the management personnel to spend excessive time during inputting the barcodes.

Moreover, as the technologies associated with the Internet become more advanced and the cell phones with camera function more popularized, most of the camera-enabled cell phone come equipped with barcode-identification capability. Therefore, barcodes may also be used to input web addresses into cell phones or help explain functions of a product, which will inevitably make it necessary to print barcodes on the obvious locations on products.

Therefore, it is urgent to effectively combine trademarks, figures, or barcodes together on products, so as to allow barcodes to be easy to find and read without disrupting the overall visual aesthetics.

### SUMMARY OF THE INVENTION

The primary objective of the invention is to propose a layer-built body having hidden barcodes and figures thereof, in which the principle of light refraction at the lenticular lens sheet is employed to allow viewers to see trademarks or figures at ordinary angles of view, and allow barcode scanning devices to read barcodes hidden in figures at specific angles of view, so that figures and barcodes may be combined together.

To achieve the aforesaid objective, a layer-built body having hidden barcodes and figures thereof, for allowing barcode scanning devices to read and identify content of the barcodes; the layer-built body comprises:

a lenticular lens sheet divided into a first surface and a second surface, and the first surface has a plurality of convex lens-shaped optical structures disposed thereon;

a patterned layer printed with trademarks or figures, and divided into a plurality of striped images; and

at least a barcode layer printed with information about barcodes and divided into a plurality of striped images; the striped images of the barcode layer are alternated with the striped images of the patterned layer to make a synthesized image layer, and are combined with the second surface of the lenticular lens sheet; wherein when a viewer looks at the layer-built body from an ordinary angle of view, the optical structures of the lenticular lens sheet allows the viewer to see contents of the patterned layer completely, and when the layer-built body is tilted at specific angles of view, the optical structures of the lenticular lens sheet allows barcode scanning devices to read contents of the barcode layer.

According to the aforesaid description, the lenticular lens sheet is made of thermoplastic resins, and the optical structures disposed on the first surface are made via rolling an embossed roller over the first surface to result in stripes of lenticular lenses arranged in linear matrices, while the second surface is a flat surface.

According to the aforesaid description, the aforesaid lenticular lens sheet may be comprised of hard and flat materials made from PET and PP, or soft and flat materials made from PVC and TPU, and the lenticular lens sheet of the invention is not limited to the aforesaid materials.

According to the aforesaid description, there should be preferably 50 to 100 stripes of lenticular lenses on the lenticular lens sheet.

According to the aforesaid description, the contents of the barcode layer may be web addresses, notes about products, or particular codes for goods related to information of the patterned layer, and the contents of the barcode layer of the invention is not limited to the aforesaid information.

According to the aforesaid description, the disclosed layer-built body of the invention has following advantages: the flip effect of the lenticular lens sheet allows viewers to alternate between different angles of view according to actual needs, so that viewers may see figures or read barcodes with barcode scanning devices. As a result, information about barcodes and figures may be provided on a fixed surface area simultaneously in the layer-built body of the invention.

### BRIEF DESCRIPTION OF DRAWINGS

FIG. 1 is an exploded view that shows a layer-built body having hidden barcodes and figures thereof according to the invention;

FIG. 2 is another exploded view that shows the layer-built body having hidden barcodes and figures thereof according to the invention, in which the patterned layer and the barcode layer are divided into a plurality of striped images;

FIG. 3 is another exploded view that shows the layer-built body having hidden barcodes and figures thereof according to the invention, in which the striped images of the patterned layer are alternated with the striped images of the barcode layer to make a synthesized image layer;

FIG. 4 is a dissected view that shows the layer-built body having hidden barcodes and figures thereof according to the invention, in which light refraction of the lenticular lens sheet induces, flip effects of images;

FIG. 5 is a schematic view that shows the actual application of the layer-built body having hidden barcodes and figures thereof to a name card, in which images from the image layer are displayed;

FIG. 6 is a schematic view that shows the actual application of the layer-built body having hidden barcodes and figures thereof to a name card, in which information about barcodes from the barcode layer are displayed.

### DETAILED DESCRIPTION OF PREFERRED EMBODIMENTS

The structure and the technical means adopted by the present invention to achieve the above and other objectives can be best understood by referring to the following detailed description of the preferred embodiments and the accompanying diagrams, wherein:

The barcode scanning devices mentioned in the invention may be cell phones that take photographs, one-dimensional or two-dimensional barcode scanners, or devices that may only read barcodes. On the other hand, contents of barcodes in the barcode layer may be one-dimensional or two-dimensional barcodes, QR Code, FP Code, or UNIS Code, and it should be noted that the barcode scanning devices and the contents of barcodes may be applied freely in accordance with any particular requirements of the invention but do not limit the invention in any ways.

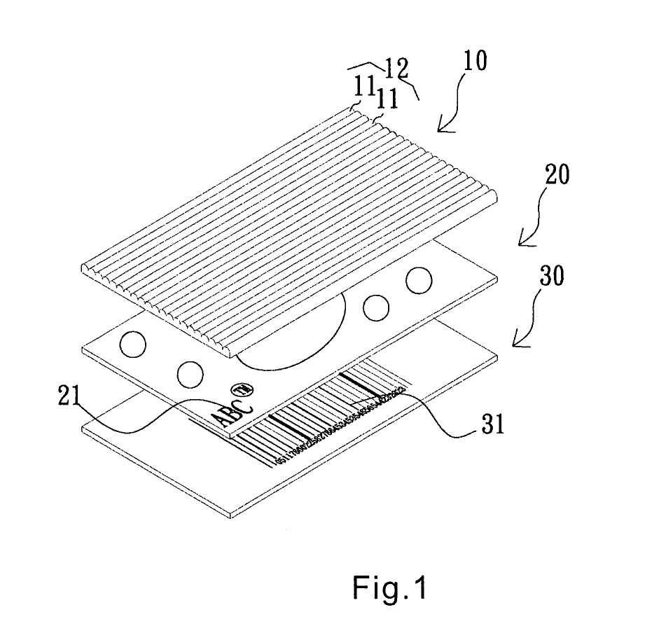

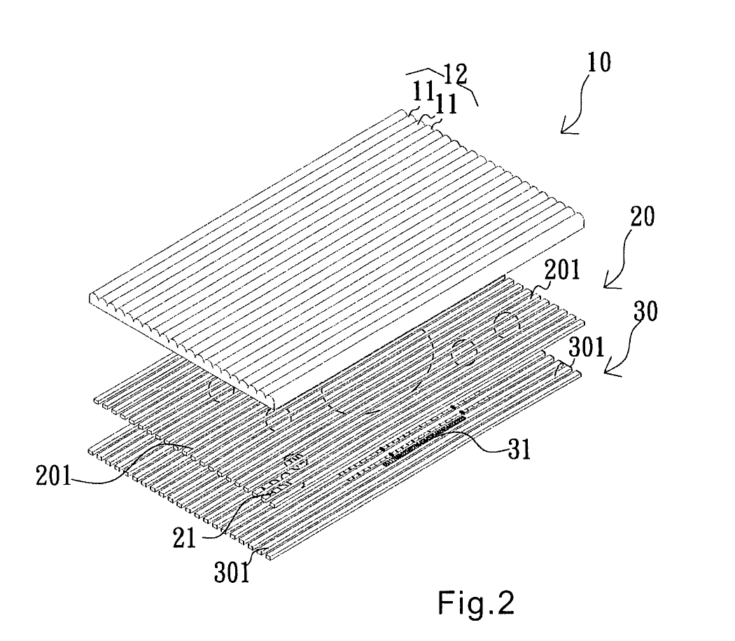

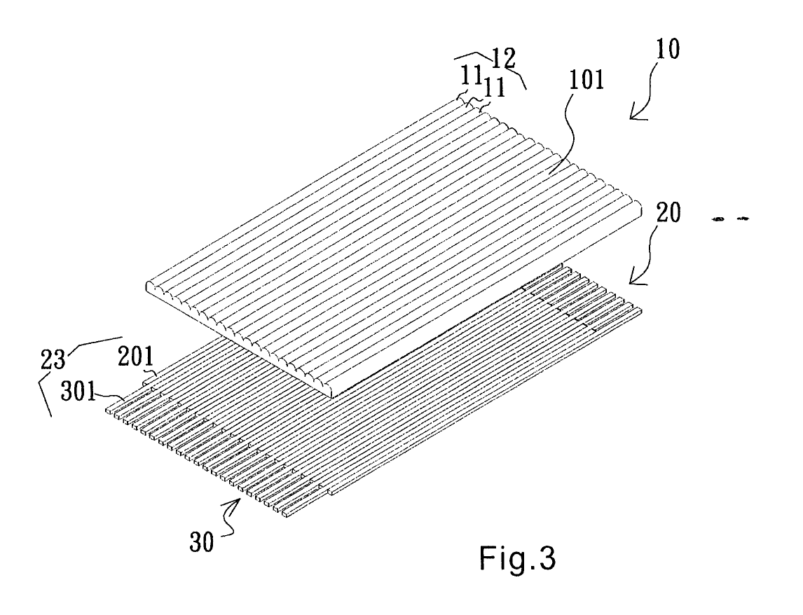

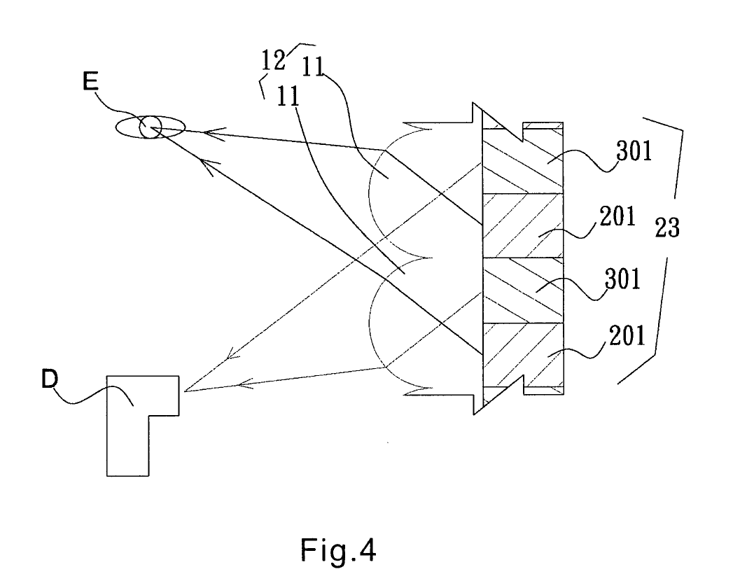

Referring to FIGS. 1 to 4; wherein FIG. 1 is an exploded view that shows a layer-built body having hidden barcodes and figures thereof according to the invention; FIG. 2 is another exploded view that shows the layer-built body having hidden barcodes and figures thereof according to the invention, in which the patterned layer and the barcode layer are divided into a plurality of striped images; FIG. 3 is another exploded view that shows the layer-built body having hidden barcodes and figures thereof according to the invention, in which the striped images of the patterned layer are alternated with the striped images of the barcode layer to make a synthesized image layer; FIG. 4 is a dissected view that shows the layer-built body having hidden barcodes and figures thereof according to the invention, in which light refraction of the lenticular lens sheet induces flip effects of images.

As shown in the figures, a layer-built body having hidden barcodes and figures thereof is disclosed in the invention, which allows the figures to be viewed and read by barcode scanning devices, the layer-built body comprises: a lenticular lens sheet 10, at least a patterned layer 20, and at least a barcode layer 30. Wherein the lenticular lens sheet 10 is comprised of thermoplastic resins such as hard and flat materials made from PET and PP, or soft and flat materials made from PVC and TPU. The lenticular lens sheet 10 is divided into a first surface 101 and a second surface 102; the first surface 101 has a plurality of optical structures 12 formed from convex lenses 11 disposed thereon, methods for making the optical structures 12 are not limited in the invention, though the optical structures 12 are preferably made via rolling a specially-made embossed roller over the first surface 101 to result in lenticular lenses 11 arranged in linear matrices, there should be preferably 50 to 100 stripes of lenticular lenses 11 on the lenticular lens sheet in order to optimize the flip effects of the images. In addition, the second surface 102 of the lenticular lens sheet 10 is a flat surface, so that the second surface 102 may be combined with the aforesaid patterned layer 20 and the barcode layer 30.

A surface of the patterned layer 20 is printed with FIG. 21 (which is depended on actual needs) such as particular trademarks, decorative figures, or photographs, and the FIG. 21 are divided into a plurality of striped images 201 (as shown in FIG. 2). The number of the patterned layer 20 in the invention is not limited, but determined by actual requirements. When it is necessary to display three FIG. 21, three layers of the patterned layer 20 is required (not shown), in which surface of each patterned layer 20 is printed with a FIG. 21, and each of the patterned layers 20 has to be divided into a plurality of striped images 201.

A surface of the barcode layer 30 is printed with information 31 about barcodes, and also divided into a plurality of striped images 301; the stripes of images 301 of the barcode layer 30 are alternated with the stripes of images 201 of the patterned layer 20 to result in a synthesized image layer 23. In addition, the information 31 is not limited to one-dimensional barcode, two-dimensional barcode, or QR Code, but may be codes that are readable by barcode scanning devices D in this invention. Contents of the information 31 may be related to the aforesaid trademarks or figures of the patterned layer; for example, when the patterned layer 20 is printed with FIG. 21 of particular trademarks, the information 31 of the barcode layer 30 may be web addresses or other notes about the trademark. Moreover, the number of the barcode layer 30 in this invention is not limited like that of the patterned layer 20, but is determined by a required number of barcodes instead. As a result, two barcode layers (not shown) need to be prepared if two information 31 are to be displayed, and the surface of each of the barcode layers 30 is printed with an information 31 before being divided into a plurality of striped images 301, and subsequently alternated with the stripes of images 201 of the patterned layer 20 to result in a synthesized image layer 23, followed by combining the synthesized image layer 23 with the second surface 102 of the lenticular lens sheet 10 (as shown in FIG. 4). Therefore, basing on the principle of light refraction at the lenticular lenses 11 of the lenticular lens sheet 10, users are allowed to view the FIG. 21 or read the information 31 with the barcode scanning device D selectively by alternating between angles of view.

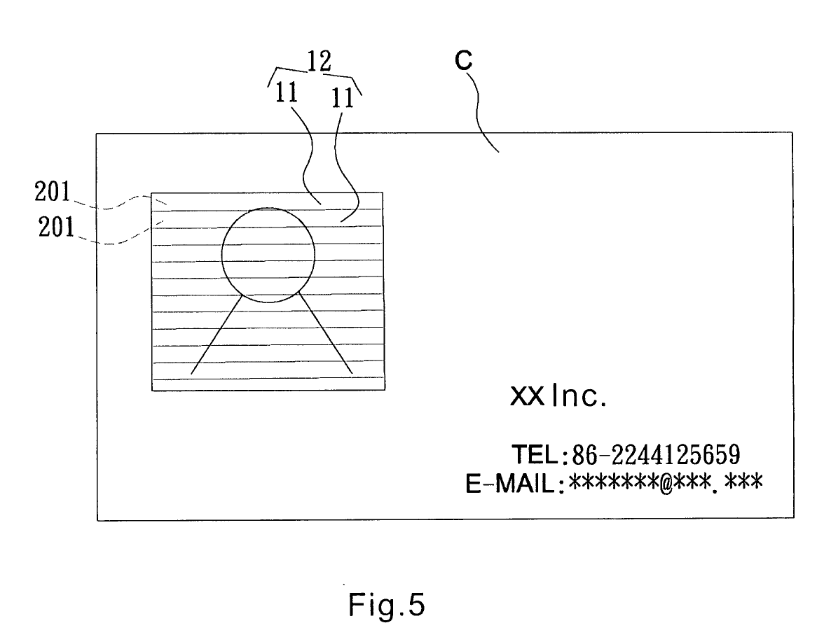

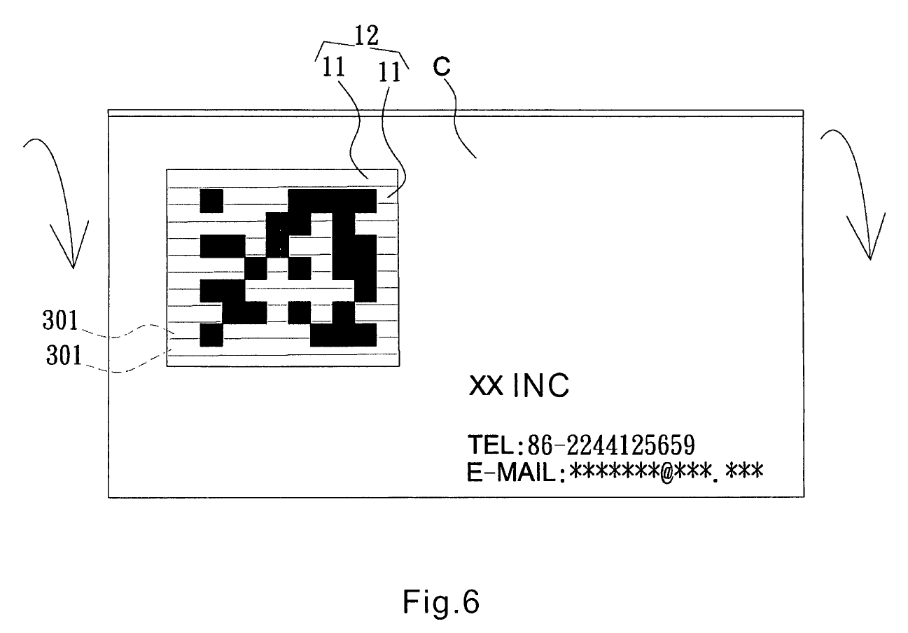

Referring to FIGS. 5 and 6, wherein FIG. 5 is a schematic view that shows the actual application of the layer-built body having hidden barcodes and figures thereof to a name card, in which images from the image layer are displayed, and FIG. 6 is a schematic view that shows the actual application of the layer-built body having hidden barcodes and figures thereof to a name card, in which information about barcodes from the barcode layer are displayed.

The disclosure of the invention may not only be applied to display trademarks or related graphics for products, but also to personal name cards C (as shown in FIG. 5), which may solve the problem of frequent failures of name card identification software in the identification of complicated Chinese characters. For example, the disclosure of the invention may be applied to a personal photograph printed on a name card C, so that information 31 about barcodes becomes hidden within the personal photograph. As a result, when name cards are exchanged between businessmen, the personal photograph may be viewed directly (as indicated in FIG. 5), and the information 31 hidden within the personal photograph may be directly read by using a barcode scanning device (as indicated in FIG. 6) and transferred into a computer via simply alternating between angles of view.

The disclosure of the invention has following advantages: The light refraction of the lenticular lens sheet induces the flip effects of images, so that users may alternate between different angles of view according to actual needs, such that users may view the figures or read the barcodes with a barcode scanning device. Therefore, barcodes that disrupt visual aesthetics are effectively hidden away from direct view by using the layer-built body of the invention, in which barcodes and figures are combined to effectively display both trademarks and decorative figures at the same time.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A layer-built body having hidden barcodes and figures thereof, for allowing barcode scanning devices to read and identify contents of the barcodes, comprising:
a lenticular lens sheet divided into a first surface and a second surface, and the first surface has a plurality of convex lens-shaped optical structures disposed thereon;
at least a patterned layer printed with trademarks or figures, and divided into a plurality of striped images; and
at least a barcode layer printed with information about barcodes and divided into a plurality of striped images, the striped images of the barcode layer are alternated with the striped images of the patterned layer to make a synthesized image layer, and adhered onto the second surface of the lenticular lens sheet;
therefore, information about barcodes and figures may be provided on a fixed surface area simultaneously.

2. The layer-built body having hidden barcodes and figures thereof according to claim 1, wherein the lenticular lens sheet is comprised of thermoplastic resins.

3. The layer-built body having hidden barcodes and figures thereof according to claim 1, wherein the first surface of the lenticular lens sheet has lenticular lenses arranged in linear matrices disposed thereon, and the second surface of the lenticular lens sheet is a flat surface.

4. The layer-built body having hidden barcodes and figures thereof according to claim 2, wherein the lenticular lens sheet may be comprised of hard and flat materials made from PET and PP.

5. The layer-built body having hidden barcodes and figures thereof according to claim 2, wherein the lenticular lens sheet may be comprised of soft and flat materials made from PVC and TPU.

6. The layer-built body having hidden barcodes and figures thereof according to claim 1, wherein the information about barcodes printed in the barcode layer may be one-dimensional barcode or two-dimensional barcode.
